(19) United States
(12) Patent Application Publication
(10) Pub. No.: US 2008/0168975 A1
(43) Pub. Date: Jul. 17, 2008

(54) Roasting oven and heating device thereof

(76) Inventor: Chiou-Fu Chang, Hsinchu Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/652,668

(22) Filed: Jan. 12, 2007

(51) Int. Cl. F24B 1/10; A47J 37/06; F24B 5/04

(52) U.S. Cl. 126/19.5; 126/21 R; 126/273 R; 219/392

(57) ABSTRACT

A roasting oven and a heating device thereof able to produce three-dimensional radiation heating of food material, mainly including a fire tray, and an igniting platform is formed at a central position thereof, which enables igniting solid fuel material thereon. After igniting, the fuel material is made to drop into lateral combustion troughs using any method, and the vacated igniting platform then provides for holding and roasting food material thereon. Heat radiation waves produced by the burning fuel material in the lateral combustion troughs form a three-dimensional angular heat radiation side wall that is able to realize synchronous omnidirectional roasting of the surface of food material. Moreover, the present invention enables easy cleaning away of ashes after finishing roasting.

### BACKGROUND OF THE INVENTION

(a) Field of the Invention

The present invention relates to a roasting oven and heating device thereof, and more particularly to the structural body of a roasting oven for roasting food materials and an internal heat generating device, specifically providing a configurational structure that enables combustion of fuel material, whereafter, a simple operating method can be used to disperse the fuel material and generate three-dimensional heat radiation waves that are able to synchronously roast the food material. Moreover, during the course of roasting, cleanliness of the location is preserved, and the structure is easy to clean after use.

(b) Description of the Prior Art

Methods of roasting food material include the conventional method of using flames from a fire located below the food material or the Japanese style of using heat waves generated above and transmitted downward towards upper surfaces of the food material, as well as appliances including a bread toaster that uses upper and lower heat sources to heat bread. Moreover, heated air is used, whereby, after actuation, synchronous three-dimensional surface heating of food material can be carried out. Furthermore, fuel material disposed in a bottom portion of a heated earthen body is used to smolder other types of food material, wherein an opening of the earthen body is covered and sealed, thereby enabling heat radiation waves emitted from the smoldering fuel material to first heat the internal air, and then transmission of the heated air heats the surface of the food material. The smoldering method indirectly heats the food material by using the air as a thermal medium, thus, taste of the roasted food material is different from that of food material roasted directly by means of heat waves, for example, roast duck must be directly heated with heat radiation waves in order for the duck meat to contract and dry up, and thereby provide a different chewing and taste experience.

Fuel material used in the aforementioned roasting appliances can be carbon fuel material or heat energy can be transformed from electric heating or gas heating. If a method is used to ignite carbon fuel material or wood material, then other subsidiary appliances must be used, or combustion can be implemented directly on a fire grate of a bottom portion of a roasting oven, resulting in ashes dropping down through perforations in the fire grate after combustion, thereby dirtying the surroundings, and air gaps in the fire grate increase the through flow rate of cold air flow, causing cold air to directly enter the roasting oven and produce a drop in temperature that affects roasting speed.

If the food material is meat, grease produced after heating the meat drips through the fire grate and defiles the surroundings, and in order to form a relatively large area of heat power, after combustion the carbon fuel material must be gripped with tongs and disposed at a relatively peripheral position interior of the roasting oven, operation procedure of which often results in burning the arms of the operator.

### SUMMARY OF THE INVENTION

A primary objective of the present invention is to provide a roasting oven that is convenient to use and effectively produces three-dimensional heat radiation waves and a heating device thereof, which uses a fire tray, and an igniting platform formed at a central portion of the fire tray enables igniting carbon fuel material; after combustion of the carbon fuel material, a simple pushing aside method is used to move the carbon fuel material into lateral combustion troughs, thereby forming a peripheral burning function, and the vacated fire tray then enables food material to be placed thereon for heating by the peripheral three-dimensional heat radiation formed by the peripheral burning of the carbon fuel material.

A second objective of the present invention is to position a fire tray at a bottom portion of a broiler.

A third objective of the present invention is to design the fire tray with a circular shape or square shape.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a cross-sectional elevational view of the primary structure according to the present invention.

FIG. 2 shows a cross-sectional elevational view of the assembled structure according to the present invention.

FIG. 3 shows a side view of an embodiment depicting igniting of carbon fuel material according to the present invention.

FIG. 4 shows a schematic view depicting pushing aside of the carbon fuel material and disposition thereof according to the present invention.

FIG. 5 shows a cross-sectional schematic view depicting roasting operation according to the present invention.

FIG. 6 shows a cross-sectional schematic view depicting heat resistance material filled in the present invention.

FIG. 7 shows an elevational view of another embodiment of a fire tray according to the present invention.

FIG. 8 shows an elevational view of another embodiment of the primary body according to the present invention.

FIG. 9 shows a side view of a downward protruding bottom tray of a broiler according to the present invention.

FIG. 10 shows a side view of an embodiment depicting disposition of a broil tray in an upper portion of the broiler according to the present invention.

FIG. 11 shows an elevational view of a grill located on the fire tray according to the present invention.

FIG. 12 shows a cross-sectional schematic view of another embodiment depicting a heating device counteracting wind according to the present invention.

FIG. 13 shows a schematic elevational view depicting disposition of a windbreak device in relation to a through hole according to the present invention.

FIG. 14 shows a schematic cross-sectional view of the windbreak device of the present invention in use.

### DETAILED DESCRIPTION OF THE PREFERRED EMBODIMENTS

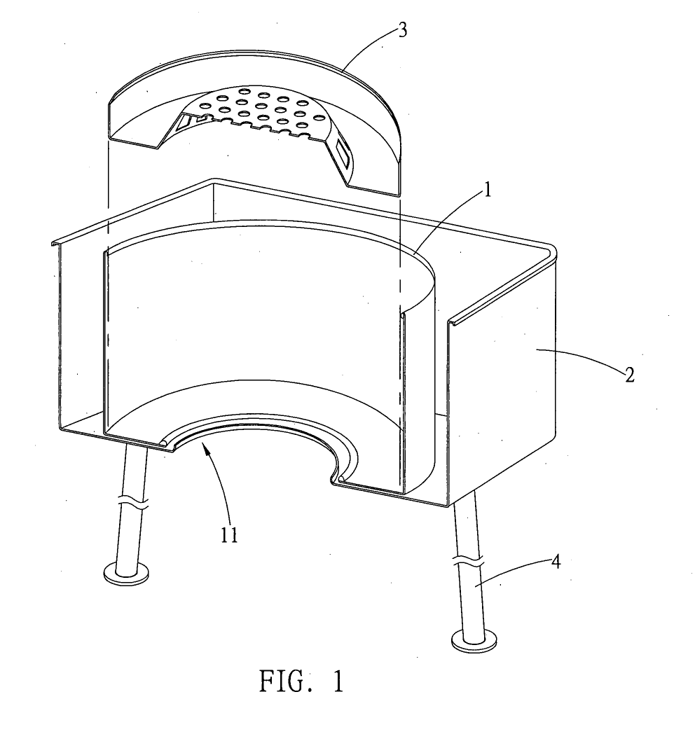

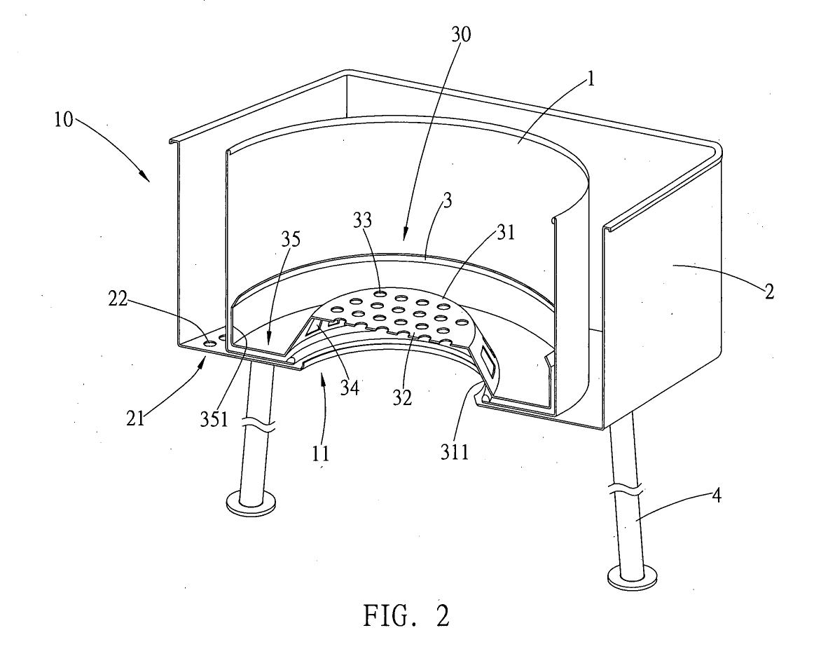

Referring to FIG. 1, which shows the present invention primarily comprising a fire tray 3 movably disposed on a through hole 11 defined in a bottom portion of a broiler 1, elevating members 4 located underneath enable clearing and supporting the present invention off the ground and a protective surrounding 2 that surrounds a periphery of the broiler 1. Referring to FIG. 2, which shows a roasting oven 10 of the present invention, primarily comprising the broiler 1, an inner bottom portion of which enables a heating device 30 to be assembled thereat, wherein the heating device 30 is the fire tray 3, the elevating members 4 are located underneath the roasting oven 10 and enable clearing and supporting the roasting oven 10 off the ground and the protective surrounding 2 that surrounds the periphery of the broiler 1.

The through hole 11 is defined in the bottom portion of the broiler 1, and a convex arched body 31 is located on an inner breadth of the fire tray 3 corresponding to position of the through hole 11. A corresponding concave combustion trough 35 is formed lateral to the arched body 31, and a top portion of the arched body 31 is a flat igniting platform 32, and perforations 33 vertically penetrate through the igniting platform 32 to enable supplying an air flow. Subsidiary air gaps 34 are defined in an inclined side wall 311 of the arched body 31, and a periphery of the combustion trough 35 is provided with a wall 351 shaped according to that of the combustion trough 35.

The broiler 1 and the surrounding 2 are joined together by means of a bottom tray 21 of the bottom portion of the surrounding 2, and convection holes 22 vertically penetrate the bottom tray 21.

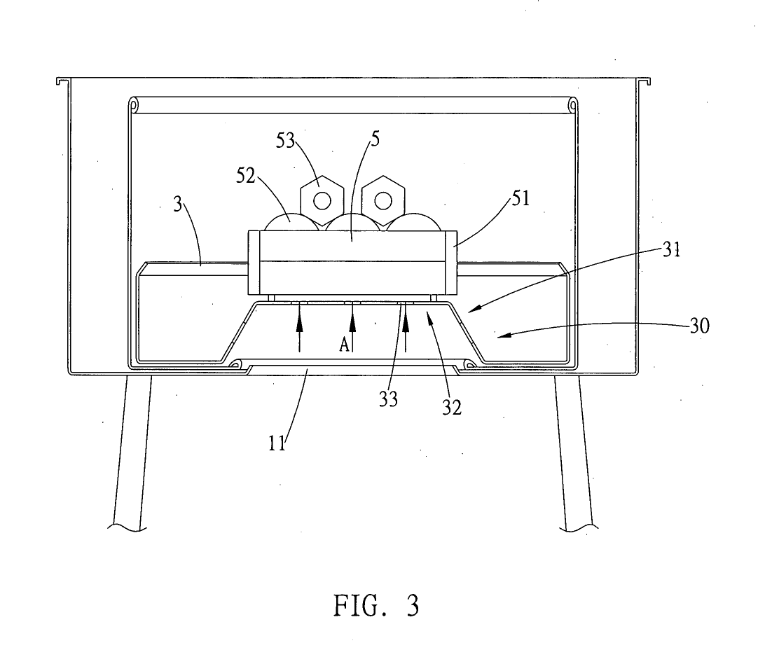

Referring to FIG. 3, which depicts application of the present invention to implement ignition operation of fuel material above an upper portion of the igniting platform 32 of the heating device 30, wherein the fuel material is a fuel assembly 5, which can be piled up carbon fuel material 52, furthermore, a packaging body 51 is provided as a surrounding periphery for the carbon fuel material 52. The raised arched body 31 and the perforations 33 defined in the igniting platform 32 enable the supply of air A, thereby allowing self-ignition of the carbon fuel material 52 after lighting. During the course of combustion of the carbon fuel material 52, heat wave conversion bodies 53 are able to realize synchronous heating of the carbon fuel material 52. The heat conversion bodies 53 are general mineral material, which, after absorbing heat, are able to convert heat waves into far-infrared waves.

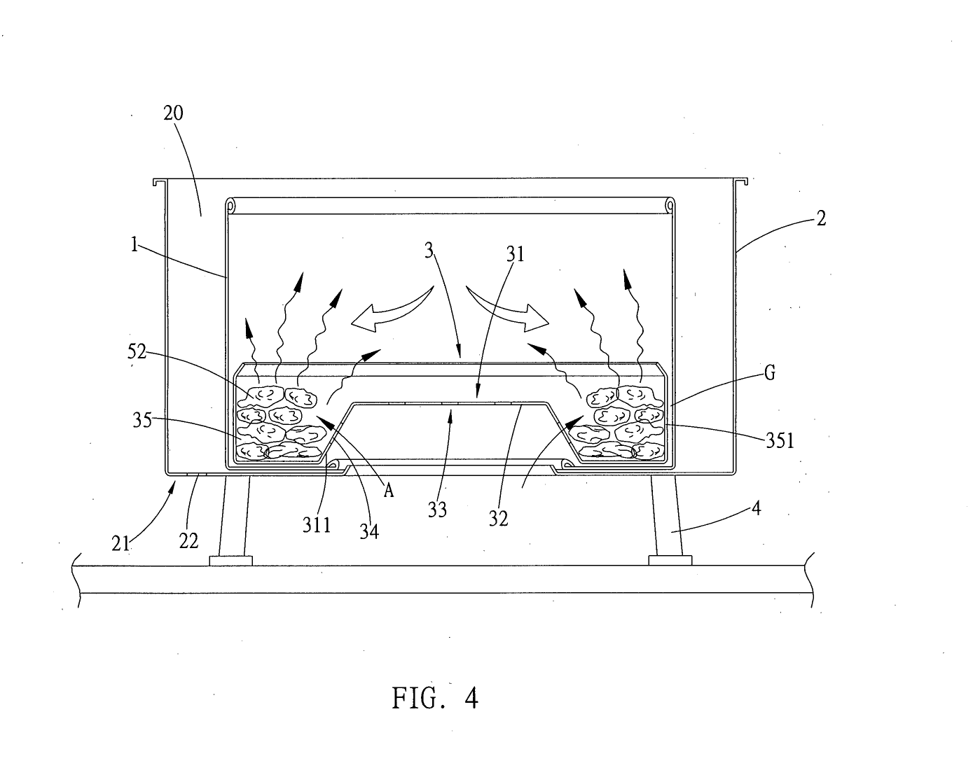

Referring to FIG. 4, after ignition as described above, the carbon fuel material 52 is then pushed aside and moved into the combustion trough 35 located lateral of the arched body 31, thereby dispersing the carbon fuel material 52 into the combustion trough 35 to enable moderate combustion of the carbon fuel material 52. Required oxygen is provided by the air A entering through the perforations 33 or the adjacent air gaps 34 defined in the side wall 311. Any simple tool able to push aside the carbon fuel material 52 can be used to implement the aforementioned operation to move the carbon fuel material 52 into the combustion trough 35, including tongs or a rodlike body able to easily push aside and cause the carbon fuel material 52 to drop into the combustion trough 35, or a shaking method can also be used to produce a centrifugal force that causes the carbon fuel material 52 to drop into the combustion trough 35. However, attention must be paid to safe operation when using such a shaking method, moreover, the internal carbon fuel material 52 may be confined by the fire tray 3 and obstructed by the igniting platform 32, thus preventing the carbon fuel material 52 from dropping into the combustion trough 35.

The bottom portion of the broiler 1 is elevated using the elevating members 4, thereby enabling the air A to enter from the space created by elevating the broiler above the ground. A periphery of the fire tray 3 forms the wall 351, and a clearance G separates the wall 351 and the broiler 1, which prevents heat waves generated by the carbon fuel material 52 from being directly conducted to the broiler 1 therethrough. Apart from the heat waves radiating upwards, other heat from the broiler 1 is prevented from being directly transmitted to the surrounding 2 by a space 20 similarly provided between the broiler 1 and the external surrounding 2, thus providing the surrounding 2 with a protective function.

The surrounding 2 is primarily fabricated from any material able to be formed into a concrete shape, and is a simple plate made from iron or iron-copper or wooden material, such as wood boards, pressed boards or bamboo splints. Materials that have heat resistant properties are preferred.

The convection holes 22 defined in the bottom tray 21 of the surrounding 2 enable cold air to enter therethrough and pass through the space 20, thereby contributing to the temperature drop to the surrounding 2, and preventing the surrounding 2 from reaching a high temperature.

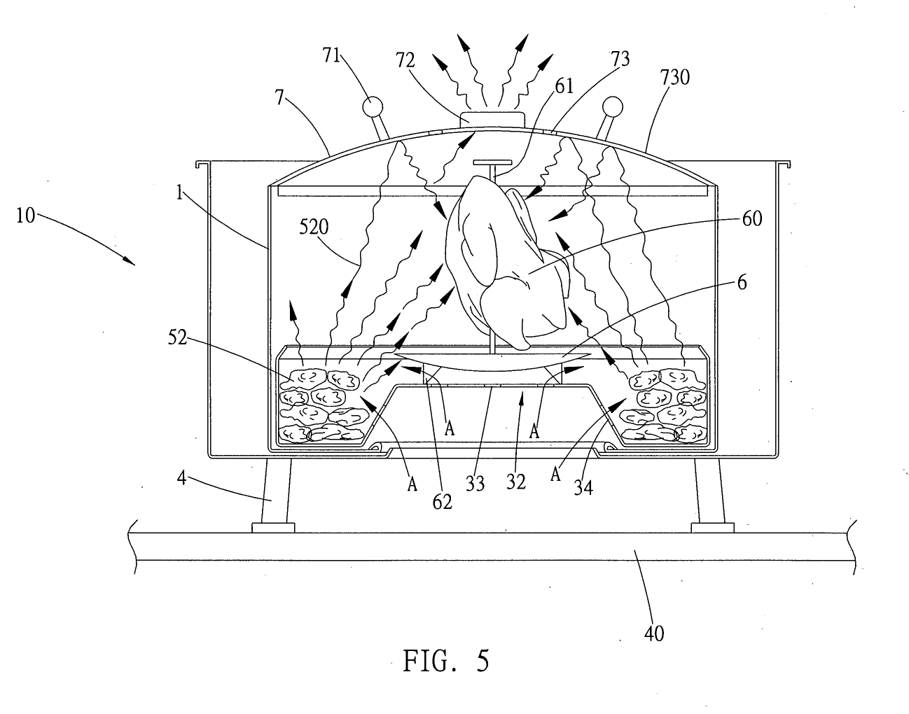

Referring to FIG. 5, which depicts implementation of the present invention in roasting food material 60, wherein after pushing aside the carbon fuel material 52 from the igniting platform 32 and causing the carbon fuel material 52 to drop into the combustion trough 35 according to the aforementioned description, the food material 60 is placed above the already vacated igniting platform 32, a cover 7 is then used to cover an upper end hole of the broiler 1. The cover 7 is fitted with handles 71, and an air flow regulating valve 72 is provided in a top end of the cover 7. The air flow regulating valve 72 enables pressure release of internal air, thereby enabling the air A entering the broiler 1 from the perforations 33 or the air gaps 34 to acquire a pressure momentum and provide the carbon fuel material 52 with oxidation requirements.

The aforementioned convection of the air A can be also implemented directly through holes 73 defined in the breadth of the cover 7, thereby enabling hot air to directly pass therethrough without being regulated. Such a configuration is applicable for use when roasting standard quantified carbon fuel material 52 and quantified food material 60, such as use in commercial locations, thereby eliminating the need for installation of the regulating valve 72 and reducing cost.

Heat radiation waves 520 produced by the carbon fuel material 52 are radiated upwardly or obliquely, thus, transmitting close to three-dimensional angular radiation to the food material 60 disposed in the upper central area of the broiler 1, and thereby enabling equalized heating of the entire external surface of the food material 60.

The inner surface of the cover 7 can be provided with a reflecting surface 730 facing the carbon fuel material 52, thereby enabling inverse reflection of the incident heat radiation waves 520 towards the food material 60. The reflecting surface 730 is able to produce an aggregation effect due to curvature of the cover 7, thereby enabling reflecting and concentrating the heat energy on the food material 60 located at the center of the broiler 1.

If the food material 60 is meat food material or food material having water content, then a tray 6 can be used to hold the food material, and the tray 6 is provided with a support device 61 to support food material or provide a clamping basis when withdrawing the food material.

Feet 62 are located below the tray 6, thereby enabling lateral flow of the air A after entering the perforations 33. The tray 6 is a disk body, interior of which is able to collect grease produced after heating the food material 60, thereby avoiding tainting the lower portion of the roasting oven 10 with grease, as well as preventing staining a tabletop 40, and maintaining cleanliness of the roasting area.

The elevating members 4 used on the tabletop 40 are of low height dimensions, if implemented on the ground, then length of the elevating members 4 can be altered by a method of assembling/disassembling feet material, thereby raising height of the roasting oven 10 above the ground, and facilitating the user in upright operation thereof.

The regulating valve 72 primarily enables pressure release of the upper aggregated hot air, wherein regulating objective is to enable modulation in speed of release of the hot air flow. If the speed of release is high, then the carbon fuel material 52 acquires an ample supply of oxygen, and is thus able to produce a substantially large heat output. However, in order to achieve a slow fire roasting of enable the food material, then the regulating valve 72 is able to lower the speed of release of the hot air flow, thereby preventing the air A from acquiring high convection kinetic energy, and retarding combustion speed of the carbon fuel material 52, thus producing low power heating.

Structural configuration of the regulating valve 72 is a general air flow rate regulating device, such as a vane-type or valve-type or blocking-type regulating valve device, and the regulating valve is of general component design, and thus not further described herein.

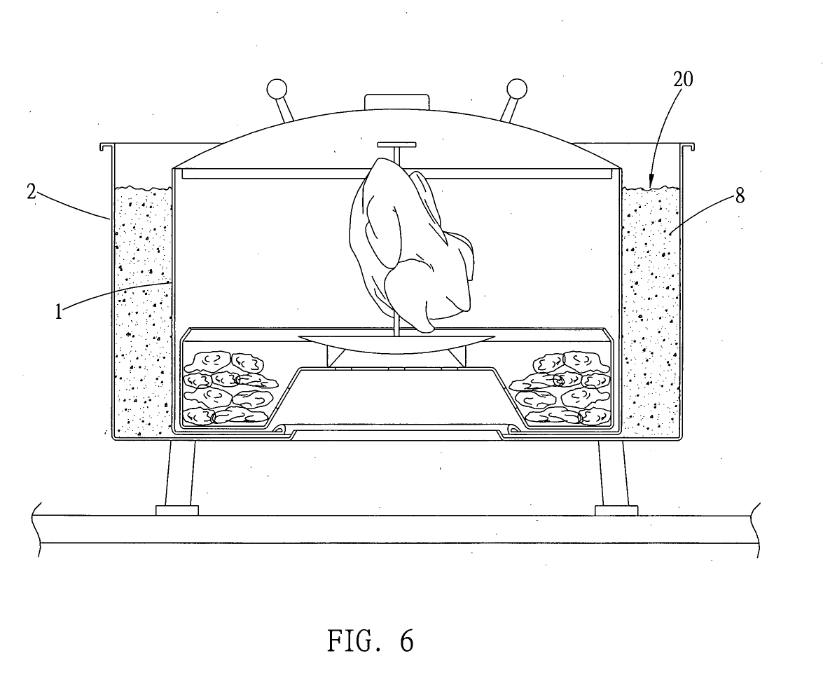

Referring to FIG. 6, which shows the space 20 provided between the broiler 1 and the surrounding protective surrounding 2, wherein the space 20 can be filled with heat resistance material 8, which can be glass wool, heat resistance chemical fiber or mineral sand grains. The space 20 filled with the heat resistance material 8 is able to effectively obstruct outward dissipation of heat waves from within the broiler 1, thereby improving heat work efficiency and serves to cut off heat to the surrounding 2. Moreover, the present invention provides flexibility in choice of material used for the surrounding 2, and enables adopting lamina wood boards as the surrounding 2.

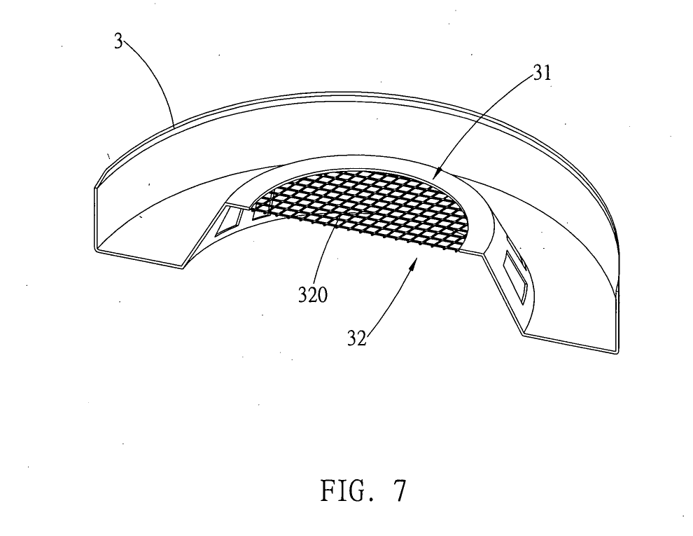

Referring to FIG. 7, which shows the igniting platform 32 of the arched body 31 at the central portion of the fire tray 3 as a flat plate form, in which can be formed a grid 320. Basic requirements of the grid 320 is that density thereof permits fuel material to be disposed thereon while enabling air to flow through, and basic form of the grid 320 is a flat surface.

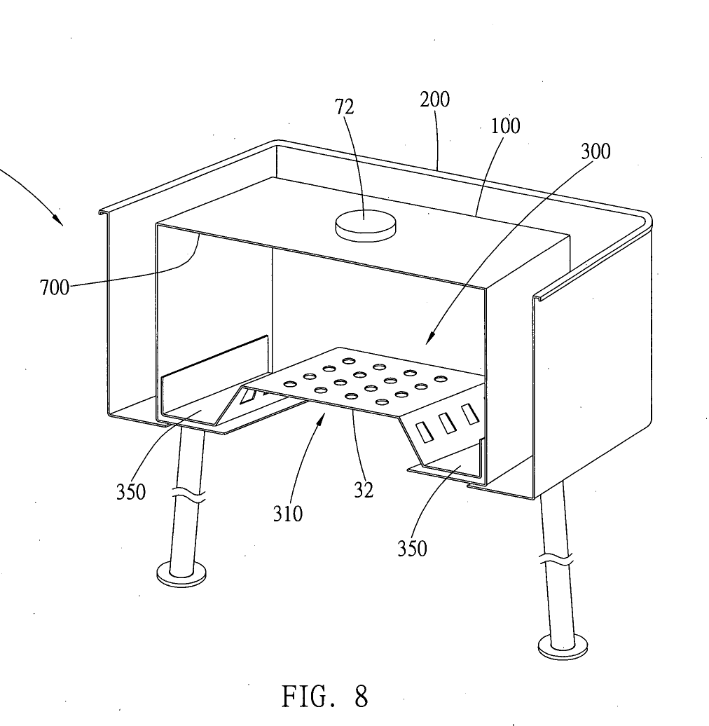

Referring to FIG. 8, in order to take into consideration and accommodate the food materials 60 having differing external forms, such as long fish or meat, the roasting oven 10 can be formed as a square shape, and, correspondingly, a broiler 100, a surrounding 200 and a fire tray 300 are all of square form. A central portion of the fire tray 300 longitudinally protrudes to form a square-shaped arched body 310, and parallel straight trench-like combustion troughs 350 are respectively formed on two sides of the arched body 310, thereby laterally separating the arched body 310 from the corresponding side walls of the broiler 100. As described above, after igniting the carbon fuel material 52, any tool can be used to similarly push aside and move the ignited carbon fuel material 52 into the straight trench-like combustion troughs 350 located lateral to the square-shaped arched body 310 to continue combustion of the carbon fuel material therein.

An upper portion of the square broiler 100 is provided with a cover plate 700 of corresponding shape, and the regulating valve 72 is similarly fitted to the cover plate 700. Long food material can be disposed on a top surface of the square-shaped arched body 310 of the igniting tray 32, and heat waves transmitted from the two side combustion troughs 350 can similarly engulf food material placed central of the broiler 100 (similar to that depicted in FIG. 6). If length of the food material is less than total length of the square-shaped arched body 310, then front and rear ends of the food material are able to receive heat radiation waves transmitted from the carbon fuel material 52 at front and rear angle ends of the combustion troughs 350 to produce oblique radiation heating of the food material, thereby similarly achieving what is equivalent to three-dimensional heating of the food material.

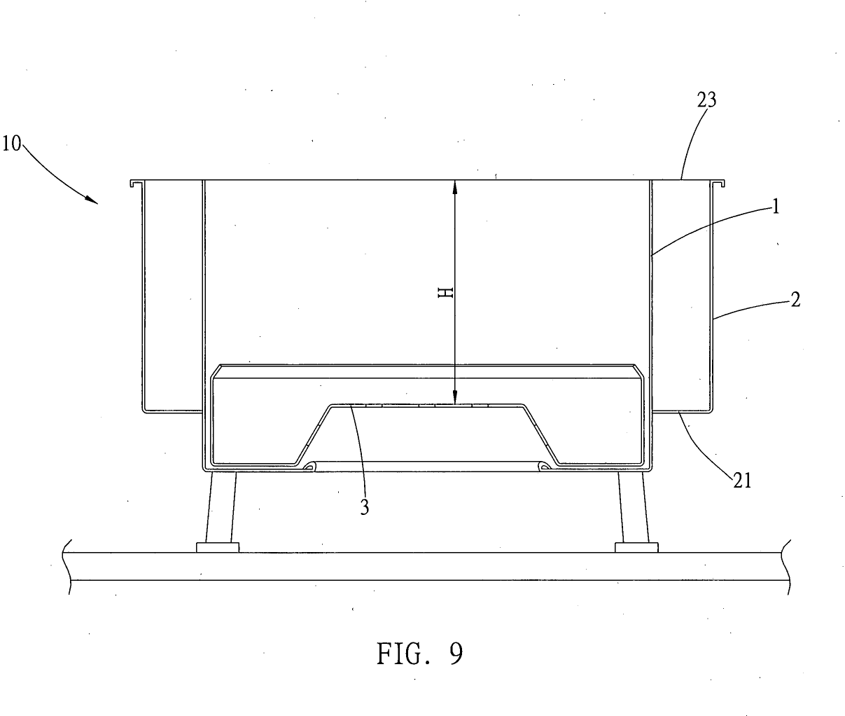

Referring to FIG. 9, in order to enlarge volume and inner space or reduce height of the surrounding 2, a bottom portion of the fire tray 3 can be made to protrude and surpass the bottom tray 21 of the surrounding 2, which apart from extending interior of the broiler 1 for heat waves generated by the carbon fuel material 52 to emanate through, a portion of the heat waves are able to emanate towards the lowered portion and be transmitted in an outward direction. The surrounding 2 serves as a horizontal lateral protective enclosure, thus, existence of the surrounding 2 prevents a user from inadvertently touching the surrounding bottom portion, and is able to reduce cost and increase volume height H of the broiler 1, thereby enabling placement and roasting of even larger food material therein.

A platform 23 can be joined between an upper opening of the surrounding 2 and a corresponding periphery of an end hole of the broiler 1 to serve as a seal end and beautify the structure or serve as a working surface for placement of additional ingredients when roasting, and two connecting points form a reinforcing mechanical strength that enable a periphery of the roasting oven 10 to sustain a relatively large mechanical impact force, thereby protecting safety of the entire structure.

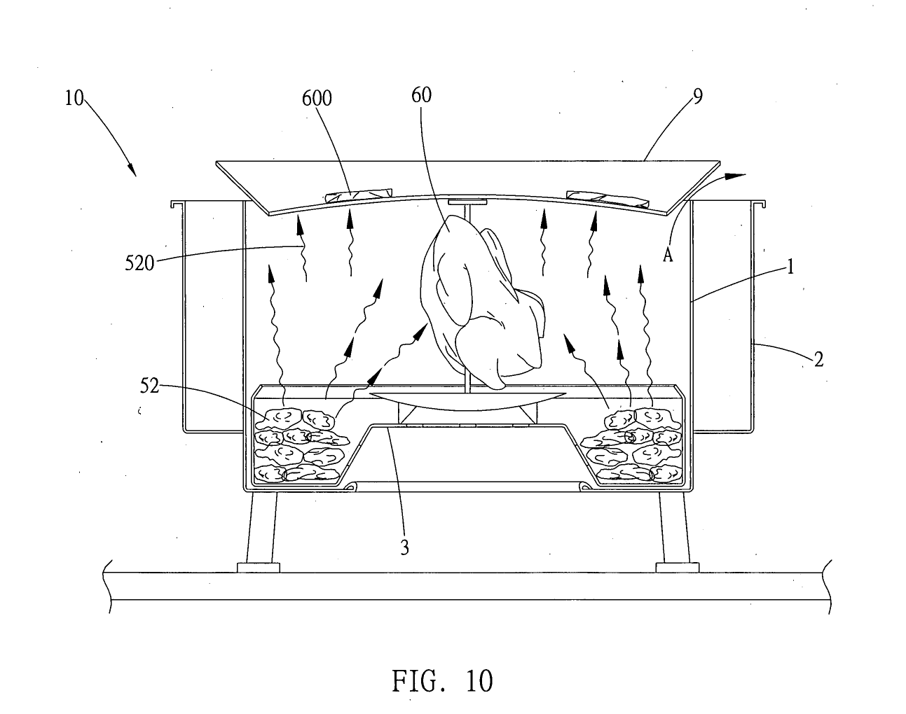

Referring to FIG. 10, according to the aforementioned description of FIG. 6, the cover 7 can be used to cover and seal the upper end hole of the broiler 1, thereby preventing emanation and dissipation of heated air. Moreover, the present invention further provides a broil tray 9 joined to the upper end hole of the broiler 1, which covers the broiler 1 and receives waste heat to serve as an auxiliary cooking utility.

Condition for implementation of the broil tray 9 is that convection passageways are able to be formed between the upper end hole of the broiler 1 and the broil tray 9, thereby enabling heated air to be outwardly discharged. Such an implementation is actualized in an embodiment having air drains formed at sides of the broil tray 9 or by means of through holes defined at suitable radially inward locations of the broil tray 9, primary function of which is to provide the air A with convection paths. The air drains or through holes are of general structural design, and thus not described herein.

After covering the upper end hole of the broiler 1, then the broil tray 9 is able to accept the heat radiation waves 520 transmitted by the carbon fuel material 52. The broil tray 9 can be fabricated from material of low specific heat or high specific heat, such as an iron, metal or mineral plate, and the upper surface of the broil tray enables broiling plate-like or small size food material 600, while interior of the broiler 1 maintains roasting of the primary food material 60. Hence, heat energy transformed from the single fire tray 3, apart from being able to roast the primary food material 60, moreover, waste heat absorption and transmission through the broil tray 9 enables synchronous broiling of the plate-like food material 600.

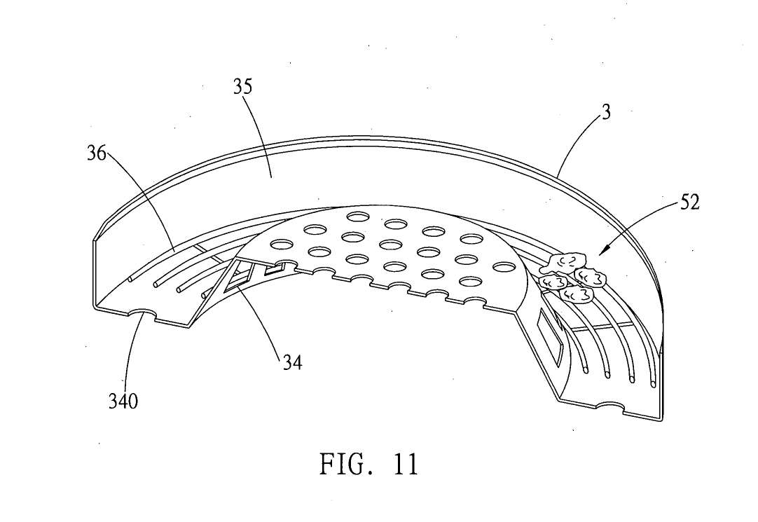

Referring to FIG. 11, the combustion trough 35 located lateral of the fire tray 3 enables secondary combustion of the carbon fuel material 52, and the air gaps 34 are able to supply a portion of oxygen. The grill 36 is transverse disposed in the combustion trough 35 to enable placing the carbon fuel material 52 thereon, then air flow directly passing through the air gaps 34 is able to completely satisfy oxygen requirements of each piece of the carbon fuel material 52, or horizontal through holes 340 defined in the bottom portion of the fire tray 3 are able to form opposite straight air flows that feed consumption needs of the carbon fuel material 52.

Height position of the grill 36 is such that apart from corresponding to position of the air gaps 34 and air flow passing therethrough, it also enables the grill 36 to sift the carbon fuel material 52. Moreover, the grill 36 can be positioned below the air gaps 34, thereby only providing functionality to sift the carbon fuel material 52 to prevent ashes from covering the carbon fuel material 52 after separating from the surface thereof during combustion, and enabling the ashes to drop below, which thus enables the carbon fuel material 52 to provide a surface area that is able to come in direct contact with oxygen during the course of combustion and satisfy oxygen consumption requirements for combustion of the carbon fuel material 52.

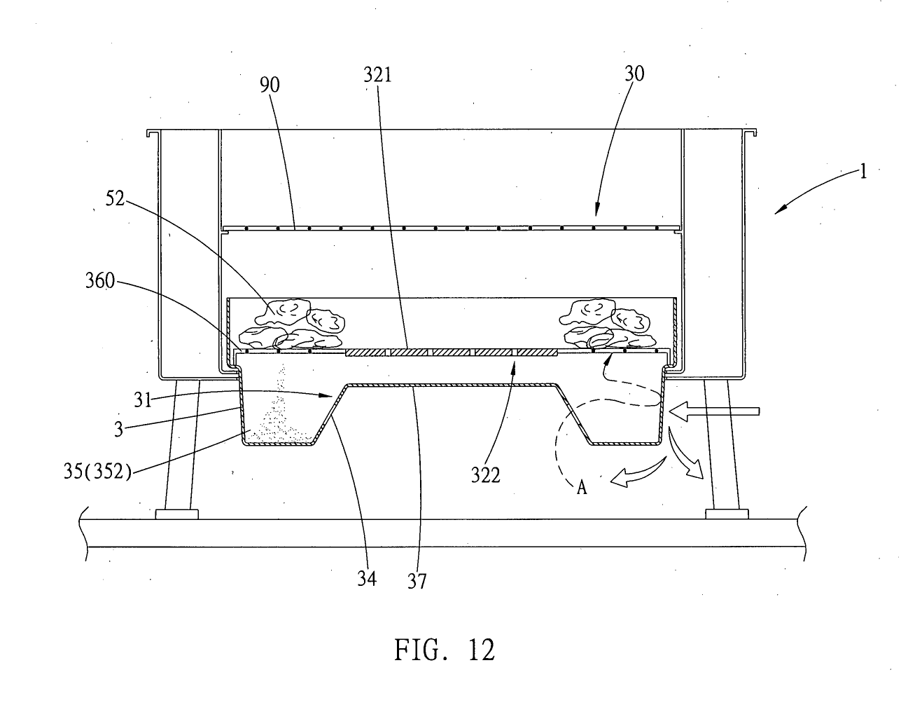

Referring to FIG. 12, which shows the bottom portion of the fire tray 3 of the heating device 30 protruding and surpassing a bottom surface of the broiler 1, and in order to counteract strong lateral air flow or streamline flow affecting combustion speed of the carbon fuel material 52, then an elevated grill 360 is movably located at the upper end hole of the fire tray 3. A central breadth of the grill 360 is joined to an igniting platform 321, and air perforations 322 are defined in a breadth of the igniting platform 321, thereby providing operating air requirements as described above.

A central portion of the fire tray 3 forms the arched body 31, a top surface of which forms a cover 37, the air gaps 34 are defined in lateral walls of the arched body 31. Hence, blowing of a strong lateral air flow first impacts an outer surface of the fire tray 3, which disperses wind pressure, while the low speed air A is turned, dissipating kinetic energy thereof during the course of turning, and enters through the air gaps 34, whereafter kinetic energy of formed heated air causes the air to naturally rise, thereby supplying working oxygen required by the carbon fuel material 52 for combustion thereof, and effectively counteracting the strong lateral air flow.

Pressure of a lateral streamline flow that flows vertically upward is dispersed after impacting the cover 37, thereby preventing any obvious influence on the carbon fuel material 52.

Another function of the cover 37 is to bear fallen carbon dust during the combustion operation, thereby avoiding dirtying the surroundings, and the function that causes turning of the air flow prevents the air A from directly blowing vertically into the broiler 1.

The original combustion troughs 35 of the fire tray 3 serve as holding troughs 352 to receive carbon ashes after combustion, whereafter the fire tray 3 can be extracted to enable discarding and cleaning out the ashes.

A barbecue wire frame 90 can be positionally joined to the internal girth of the broiler 1, thereby enabling food material to be placed on the wire frame 90 and absorb heat.

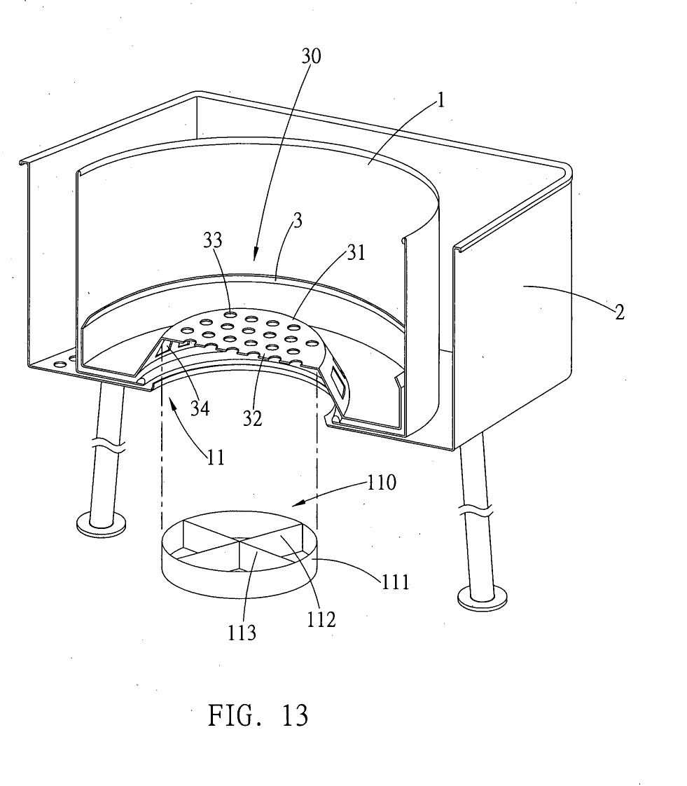

Regardless of whether the aforementioned heating device implementation is attached inside a broiler or is an independent body, a windbreak device 110 may be additionally located at a bottom portion of the related heating device 30, as shown in FIG. 13, wherein a cruciform assembly of partitions 112, 113 divides an interior of an enclosing ring 111. If the windbreak device 110 is disposed at position of the through hole 11 at the bottom portion of the surrounding body 2, then lateral air currents can be prevented from directly entering the fire tray 3, and the perforations 33 defined in the arched body 31 produce fast air current turbulence while the air gaps 34 can affect variation in combustion rate, thereby achieving effectiveness of enabling roasting food material placed on the igniting platform 32 to receive uniform temperature, and enables the igniting platform 32 to attain a relatively stable air current during the initial firing stage, thus benefiting the firing operation.

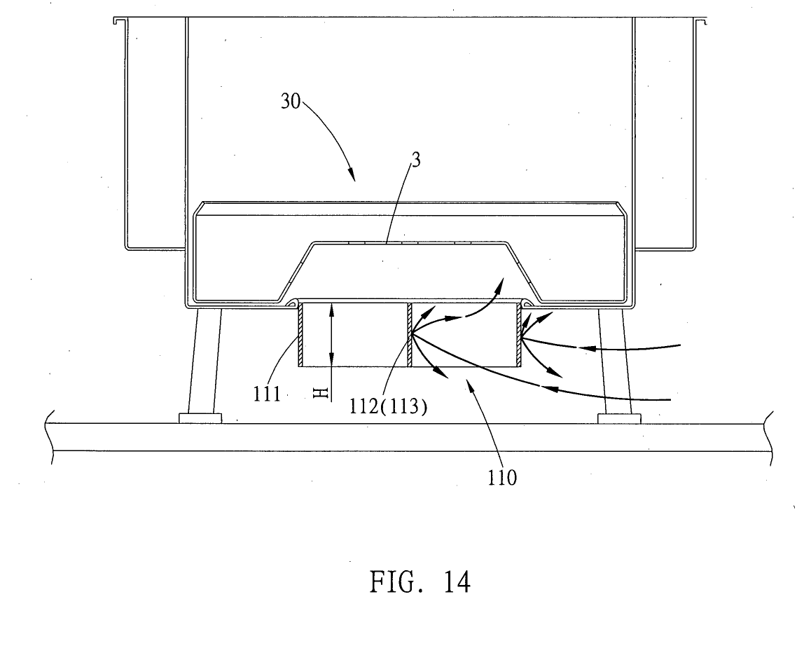

Referring to FIG. 14, which shows the bottom portion of the fire tray 3 of the heating device 30 joined to the windbreak device 110, thereby enabling the enclosing ring 111 to block and disperse lateral wind pressure, and the cruciform assembly of the partitions 112, 113 interior of the windbreak device 110 enable secondary breaking up and dispersing of strong air currents blowing in from all side directions, thereby causing current flow velocity to slow down before entering the heating device 30. Because the windbreak device 110 is provided with a certain height H, thus, existence of such provides direct resistance to lateral air currents, and avoids directly drawing the air currents into the heating device 30, thereby effectively containing strong lateral air currents, facilitating firing outdoors or the roasting operation.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A roasting oven, able to produce multiangular heat radiation heating of food material and a heating device thereof, comprising:
a broiler that uses elevating members to clear and support the roasting oven off the ground, and a through hole is defined central of a bottom portion of the broiler;
a fire tray movable joined to an inner bottom portion of the broiler, a central portion of the fire tray forms an arched body, central of which is an igniting platform, and a combustion trough is formed lateral to a circumference of the igniting platform, perforations are defined in the igniting platform to enable flow of oxygen therethrough.

2. The roasting oven according to claim 1, wherein a cover covers and seals an upper portion of the broiler, and an air flow regulating valve is fitted to the cover.

3. The roasting oven according to claim 1, wherein a periphery of the broiler is provided with a protective surrounding.

4. The roasting oven according to claim 1, wherein air gaps are defined in side walls of the arched body of the fire tray.

5. The roasting oven according to claim 1, wherein a bottom portion of the broiler descends and surpasses a bottom tray of the surrounding.

6. The roasting oven according to claim 3, wherein a platform is joined between an upper opening of the surrounding and an end hole of the broiler.

7. The roasting oven according to claim 1, wherein a grill is movably joined to an upper end hole of the fire tray, the igniting platform is located at a center of the grill, and air perforations vertically penetrate the igniting platform; a center of the fire tray is the arched body, a top surface of which is a cover, and the air gaps are defined in the side walls of the arched body.

8. A roasting heating device, able to produce multiangular heat radiation waves for roasting food material, comprising a fire tray, center of which forms a protruding arched body, a combustion trough is formed at a circumference of the arched body, a central top surface of the arched body is an igniting platform, and air perforations penetrate a platform of the igniting platform.

9. The roasting heating device according to claim 8, wherein the fire tray is movably joined to a bottom portion of a broiler, and through holes are defined in the bottom portion of the broiler; the entire structure is supported above the ground by means of elevating members.

10. The roasting heating device according to claim 8, wherein the fire tray is of circular form, and the combustion trough is peripherally formed to be annular shaped.

11. The roasting heating device according to claim 8, wherein the fire tray is square shaped, two sides of which are respectively provided with a combustion trough, parallel separated by the arched body.

12. The roasting heating device according to claim 10, wherein grills are laid in the combustion trough of the fire tray.

13. The roasting heating device according to claim 11, wherein grills are laid in the combustion trough of the fire tray.

14. The roasting heating device according to claim 8, wherein a grill is movably joined to an upper end hole of the fire tray, the igniting platform is formed at a center of the grill, and perforations vertically penetrate the igniting platform; a central portion of the fire tray is the arched body, a top surface of which is a cover, and air gaps are defined in the side wall of the arched body; an air flow clearance separates the cover and the igniting platform.

15. The roasting oven according to claim 3, wherein a space separates the surrounding and the broiler, and the space is filled with heat resistance material.

16. The roasting oven according to claim 1, wherein a wire frame is movably joined to an internal girth of the broiler.

17. The roasting oven according to claim 1, wherein a ring-shaped windbreak device is located at the bottom portion of the fire tray, the windbreak device is an enclosing ring, interior of which are arranged a cruciform assembly of vertical partitions.
